(19) United States
(12) Patent Application Publication
(10) Pub. No.: US 2026/0162061 A1
(43) Pub. Date: Jun. 11, 2026

(54) INFORMATION PROCESSING APPARATUS

(71) Applicant: NEC Corporation, Tokyo (JP)

(72) Inventor: Kei TAKEMURA, Tokyo (JP)

(73) Assignee: NEC Corporation, Tokyo (JP)

(21) Appl. No.: 19/390,799

(22) Filed: Nov. 17, 2025

(30) Foreign Application Priority Data
Dec. 9, 2024 (JP) 2024-214423

(51) Int. Cl. G06Q 10/087

(52) U.S. Cl. CPC G06Q 10/08726; G06Q 10/0877

(57) ABSTRACT

An information processing apparatus of the present disclosure includes: an update unit configured to update a second inventory standard based on comparison between a first inventory standard to be a standard of a product inventory quantity and the second inventory standard to be a target value of the first inventory standard; a change unit configured to change the first inventory standard when the second inventory standard cannot be updated based on the comparison; and an output unit configured to output the first inventory standard having been changed. This configuration facilitates swift AI-based decision making for optimal replenishment quantities.

### INCORPORATION BY REFERENCE

This application is based upon and claims the benefit of priority from Japanese patent application No. 2024-214423, filed on Dec. 9, 2024, the disclosure of which is incorporated herein in its entirety by reference.

### TECHNICAL FIELD

The present disclosure relates to an information processing apparatus.

### BACKGROUND ART

In a store that sells products, management of the inventory of the products is important. For example, Patent Literature 1 describes determining whether the inventory is insufficient or surplus based on the number of products in stock and the number of products shipped.
Patent Literature 1: Japanese Unexamined Patent Application Publication No. 2021-039532

### SUMMARY

However, even in the case of determining whether the inventory of products is insufficient or surplus based on the shipment quantity as described in Patent Literature 1, it is difficult to predict a subsequent shipment quantity, and it is difficult to determine an appropriate replenishment quantity of products. As a result, there arises a problem that it is difficult to perform appropriate management of the inventory of products.

Accordingly, an object of the present disclosure is to solve the abovementioned problem that it is difficult to appropriately manage the inventory of products.

An information processing apparatus as an aspect of the present disclosure includes: an update unit configured to update a second inventory standard based on comparison between a first inventory standard to be a standard of a product inventory quantity and the second inventory standard to be a target value of the first inventory standard; a change unit configured to change the first inventory standard when the second inventory standard cannot be updated based on the comparison; and an output unit configured to output the first inventory standard having been changed.

Further, an information processing method as an aspect of the present disclosure includes: updating a second inventory standard based on comparison between a first inventory standard and the second inventory standard, the first inventory standard being a standard of a product inventory quantity, the second inventory standard being a target value of the first inventory standard; changing the first inventory standard when the second inventory standard cannot be updated based on the comparison; and outputting the first inventory standard having been changed.

Further, a program as an aspect of the present disclosure includes instructions for causing an information processing apparatus to: update a second inventory standard based on comparison between a first inventory standard and the second inventory standard, the first inventory standard being a standard of a product inventory quantity, the second inventory standard being a target value of the first inventory standard; change the first inventory standard when the second inventory standard cannot be updated based on the comparison; and output the first inventory standard having been changed.

Configured as described above, the present disclosure facilitates appropriate management of the inventory of products.

### BRIEF DESCRIPTION OF THE DRAWINGS

FIG. 1 is a block diagram showing an example of a configuration of an information processing apparatus according to the present disclosure;

FIG. 2 is a flowchart showing an example of processing operation of the information processing apparatus according to the present disclosure;

FIG. 3 is a diagram showing an example of data relating to the present disclosure;

FIG. 4 is a diagram showing an example of data relating to the present disclosure;

FIG. 5 is a diagram showing an example of data relating to the present disclosure;

FIG. 6 is a block diagram showing an example of a hardware configuration of an information processing apparatus according to the present disclosure;

FIG. 7 is a block diagram showing an example of a configuration of the information processing apparatus according to the present disclosure; and

FIG. 8 is a flowchart showing an example of processing operation by the information processing apparatus according to the present disclosure.

### EXAMPLE EMBODIMENT

### First Example Embodiment

A first example embodiment of the present disclosure will be described with reference to the drawings. The drawings may relate to any example embodiment.

An information processing apparatus 10 of the present disclosure is, as an example, used to determine an appropriate replenishment quantity of products when performing product inventory management. More specifically, in this example embodiment, in product inventory management, by updating and setting an inventory standard to be the standard of the inventory quantity of products and a target inventory standard to be a target value thereof, determination of a more appropriate replenishment quantity of products is facilitated based on a current product inventory quantity and the inventory standard.

Although a case where products to be mainly subjected to inventory management is one item will be illustrated below, the present disclosure can be applied to a case where the inventories of a plurality of items of products are collectively managed. In addition, in the present disclosure, the interval between timings of updating the inventory standard and the target inventory standard or determining the replenishment quantity of products is expressed as a “period” and may be any interval such as day, week, month, or quarter. For example, in a case where the “period” is a “day”, an order is placed in the night of the previous day and product is received in the morning of the same day, and the daytime of the same day is demand during the period, and the evening of the same day is the end of the period.

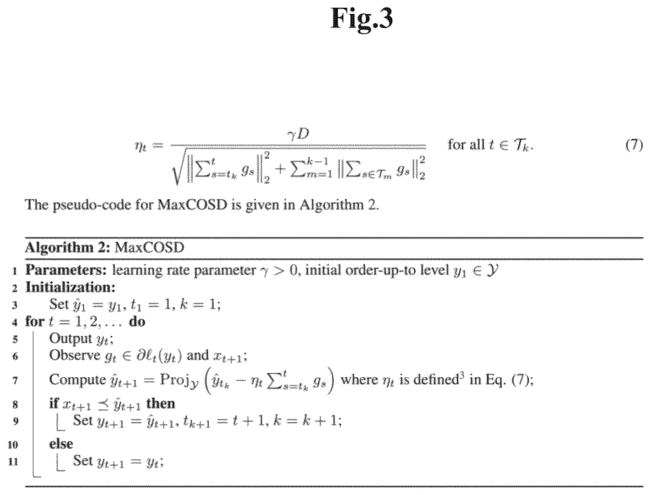

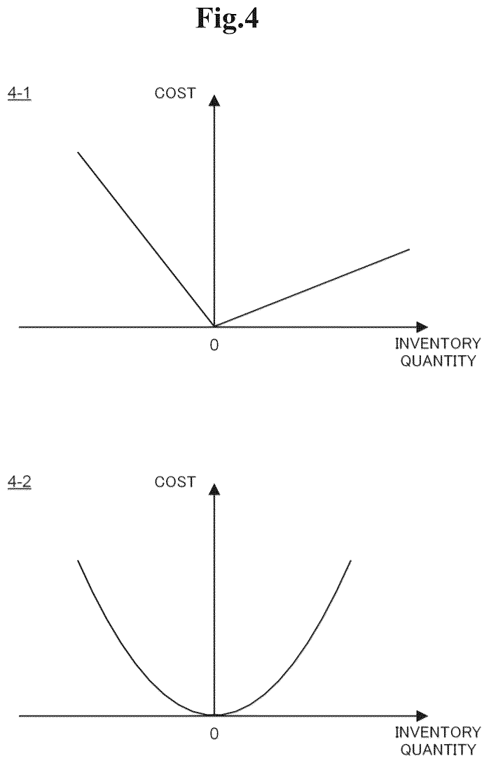

First, a technique relating to the present disclosure will be described. FIG. 3 shows an example of an algorithm that updates a target inventory standard based on a cost that is a loss based on a product inventory standard and a product inventory quantity. The cost based on the product inventory quantity is expressed, for example, as shown in FIG. 4(4-1) and FIG. 4(4-2), by a cost function such that a cost due to a storage expense increases as the inventory quantity increases (surplus) and a cost due to an opportunity loss of sales increases as the inventory quantity becomes insufficient. The cost function shown in FIG. 4 is an example, and the cost function is not limited to the one shown in FIG. 4.

Then, in the algorithm shown in FIG. 3, a current inventory standard yₜ, a demand gₜ, and an inventory quantity xₜ₊₁ are obtained first. Herein, the demand gₜ is expressed by a gradient in the cost function as shown in FIG. 4, and represents a subdifferential in the current inventory quantity xₜ₊₁. Moreover, as shown in line 7 of the algorithm, a target inventory standard shown by Formula 1 below is calculated based on a previous target inventory standard and on a parameter n and a gradient g corresponding to a learning rate y shown in Formula (7) in FIG. 3. Then, when the inventory quantity xₜ₊₁ is less than or equal to the target inventory standard as shown in lines 8 and 9 of the algorithm, the target inventory standard can be updated.

$${\hat{y}}_{t + 1} \qquad [ Formula 1 ]$$

On the other hand, as shown in lines 10 and 11 of the algorithm, when the inventory quantity xₜ₊₁ is greater than the target inventory standard, the current inventory standard yₜ is maintained. That is to say, when a demand for the product is low and the inventory quantity does not decrease significantly, the inventory standard quantity continues to be maintained, and the product must be replenished up to the inventory standard quantity again. Here, to given an example with numerical values, when the current inventory standard is 100 units, the target inventory standard is 70 units, and the inventory quantity is 90 units, the inventory quantity of 90 units is not below the target inventory standard of 70 units, so that the current inventory standard of 100 units is maintained, and the product needs to be replenished up to the inventory quantity of 100 units. Therefore, in the algorithm shown in FIG. 3, there is a problem that the inventory cannot be reduced unless a demand increases, and therefore appropriate inventory management cannot be performed.

To solve the problem as described above, the information processing apparatus 10 in this example embodiment is configured in the following manner. Below, an example of the configuration and operation of the information processing apparatus 10 in this example embodiment will be described.

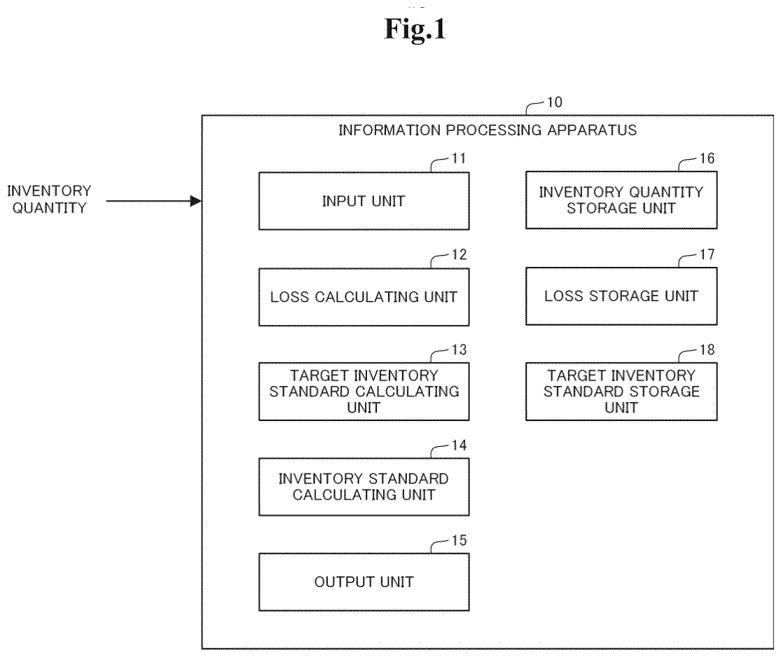

The information processing apparatus 10 is configured with one or a plurality of information processing apparatuses each including an arithmetic logic unit and a memory unit. Then, as shown in FIG. 1, the information processing apparatus 10 includes an input unit 11, a loss calculating unit 12, a target inventory standard calculating unit 13, an inventory standard calculating unit 14, and an output unit 15. The respective functions of the input unit 11, the loss calculating unit 12, the target inventory standard calculating unit 13, the inventory standard calculating unit 14, and the output unit 15 can be implemented by execution of a program for implementing the respective functions stored in the memory unit by the arithmetic logic unit. Further, the information processing apparatus 10 includes an inventory quantity storage unit 16, a loss storage unit 17, and a target inventory standard storage unit 18 that are implemented by the memory unit.

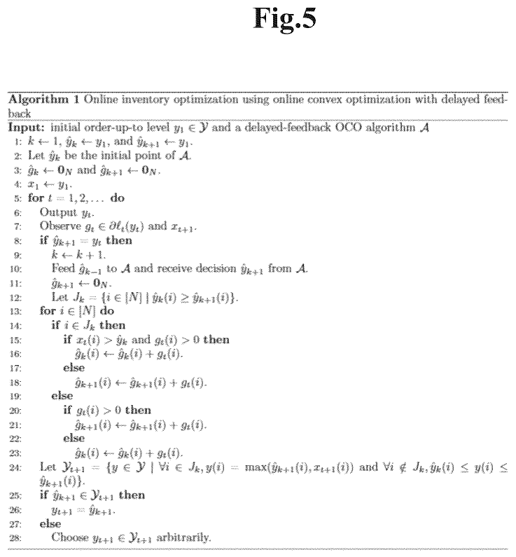

Then, the information processing apparatus 10 described above is configured to execute the processing of the algorithm shown in FIG. 5. The function and operation of each component will be described below with reference to the algorithm of FIG. 5.

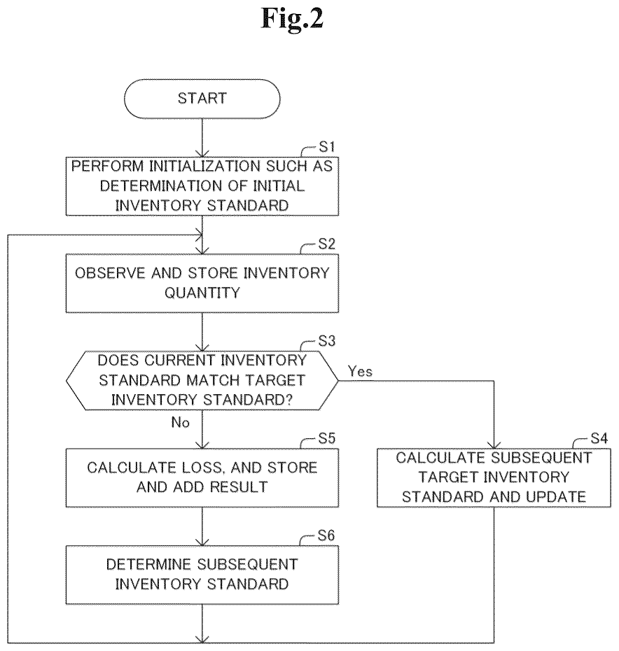

First, as shown in lines 1 to 4 of the algorithm, the information processing apparatus 10 initializes various parameters by determination of an initial inventory standard y, and so forth (step S1 of FIG. 2). Then, as shown in lines 5 to 7 of the algorithm, the input unit 11 of the information processing apparatus 10 observes a current inventory quantity xₜ₊₁ and a gradient gₜ corresponding to the inventory quantity xₜ₊₁ in a cost function, and stores into the inventory quantity storage unit 16 (step S2 of FIG. 2). Note that t denotes, for example, a period such as a day or a week.

Subsequently, the information processing apparatus 10 causes the target inventory standard calculating unit 13 (update unit) to check whether a current inventory standard yₜ matches a target inventory standard shown in Formula 1. Then, when it matches (Yes at step S3 of FIG. 2), the target inventory standard calculating unit 13 calculates and updates a subsequent target inventory standard, and stores it into the target inventory standard storage unit 18 (step S4 of FIG. 2). Here, since it is in the initial state, the subsequent target inventory standard is calculated. Therefore, the target inventory standard calculating unit 13 calculates the target inventory standard by using a preset algorithm A as shown in line 10 of the algorithm. For example, as shown in FIG. 3 described above, the target inventory standard calculating unit 13 calculates the subsequent target inventory standard and updates based on the current inventory standard serving as the previous target inventory standard and a loss g based on a parameter n and a gradient corresponding to a learning rate y. Here, it is assumed that the current inventory standard is 100 units and the target inventory standard is calculated as 70 units and updated. The calculation of the target inventory standard will be described later.

Subsequently, the information processing apparatus 10 returns to the observation of the current inventory quantity by the input unit 11 (step S2 of FIG. 2). Then, the information processing apparatus 10 causes the target inventory standard calculating unit 13 to check whether the current inventory standard (first inventory standard) matches the target inventory standard (second inventory standard) (step S3 of FIG. 2). In this case, since the current inventory standard is 100 units and the target inventory standard is 70 units, they do not match (No at step S3 of FIG. 2). Then, the loss calculating unit 12 (calculating unit) of the information processing apparatus 10 calculates a loss corresponding to the current inventory quantity (step S5 of FIG. 2). For example, the loss calculating unit 12 calculates a loss (cost) based on a subgradient of a cost function such that the value of a loss increases as the product inventory quantity is more surplus and more insufficient as shown in FIGS. 4(4-1) and 4-2 described above. Furthermore, the loss calculating unit 12 allocates the calculated loss to either a loss corresponding to the previous target inventory standard that is the current inventory standard (first loss) or a loss corresponding to the current target inventory standard (second loss), and stores it into the loss storage unit 17. In the algorithm, the loss is expressed by Formula 2, where the loss corresponding to the current inventory standard is given a subscript k as a loss of the k^{th} cycle and a loss corresponding to the current target inventory standard is given a subscript k+1 as a loss of the k+1^{th} cycle.

$$\hat{g} \qquad [ Formula 2 ]$$

For example, as shown in lines 13 to 23 of the algorithm, the loss calculating unit 12 accumulates by allocating the calculated loss to the loss of the k^{th} cycle, that is, the loss corresponding to the current inventory standard, which is the loss of the k^{th} cycle, that is, the previous target inventory standard (subscript k), and the loss of the k+1^{th} cycle, that is, the loss corresponding to the current target inventory standard (subscript k+1), based on the positive or negative subgradient of the cost function. In this example, it is accumulated by allocating to the loss corresponding to the current inventory standard of 100 units, which is the previous target inventory standard (subscript k), and the loss corresponding to the current target inventory standard of 70 units (subscript k+1).

Subsequently, since the current inventory standard (first inventory standard) does not match the target inventory standard (second inventory standard) in the above processing and the target inventory standard cannot be updated, the information processing apparatus 10 causes the inventory standard calculating unit 14 (change unit) to change the value of the current inventory standard yₜ and determines it as a subsequent inventory standard yₜ₊₁ as shown in line 28 of the algorithm (step S6 of FIG. 2). At this time, the inventory standard calculating unit 14 changes the value of the current inventory standard to a closer value to the value of the target inventory standard, for example. As an example, in a case where the current inventory standard is 100 units and the target inventory standard is 70 units, the inventory standard calculating unit 14 may change the current inventory standard of 100 units to 90 units and determine it as the value of a subsequent inventory standard. At this time, the inventory standard calculating unit 14 may change the value of the current inventory standard based on the value of the inventory quantity and determine it as the value of a subsequent inventory standard. As an example, in a case where the inventory quantity is 90 units, the inventory standard calculating unit 14 may change the current inventory standard of 100 units to 90 units based on the value of the inventory quantity and determine it as the value of a subsequent inventory standard.

Subsequently, the information processing apparatus 10 causes the output unit 15 to output the changed inventory standard as a current inventory standard. Consequently, inventory management is performed based on the value of the changed inventory standard. As an example, since the current inventory quantity is 90 units and the current inventory standard has been changed to 90 units, there is no need to further replenish the product. Then, the information processing apparatus 10 proceeds to the next cycle, and repeats the same processing as described above (steps S2 to S6 of FIG. 2). That is to say, the information processing apparatus 10 sets the changed inventory standard as the value of a new current inventory standard and keeps the value of the target inventory standard the same as in the previous one, thereby observing the current inventory quantity and repeating the abovementioned processing.

Thus, in this example embodiment, it is possible to change a current inventory standard that is not changed in the algorithm of FIG. 3 described above. Then, by repeating the abovementioned processing, it is expected that the value of the inventory standard will eventually match the value of the target inventory standard. Now, a case will be described in which the abovementioned processing is repeated and the current inventory standard thereby matches the target inventory standard afterward. As an example, assume that, by repeating the abovementioned processing in the state where the inventory standard is 100 units and the target inventory standard is 70 units, the value of the inventory standard is changed to 70 units. Then, since the inventory standard of 70 units matches the target inventory standard of 70 units (Yes at step S3 of FIG. 2), the target inventory standard calculating unit 13 calculates a subsequent target inventory standard and updates (step S4 of FIG. 2). It should be noted that the target inventory standard calculating unit 13 is not necessarily limited to updating the target inventory standard when the inventory standard and the target inventory standard match, and the target inventory standard calculating unit 13 may update the target inventory standard when the inventory standard becomes less than or equal to the target inventory standard, and may update the target inventory standard when a preset criterion is satisfied as a result of comparison between the inventory standard and the target inventory standard.

Then, as shown in line 10 of the algorithm, the target inventory standard calculating unit 13 calculates and updates the target inventory standard by a preset algorithm A, using the loss shown in Formula 2 accumulated as described above. To be specific, when calculating the subsequent target inventory standard (subscript k+1) from the current target inventory standard of 70 units (subscript k) and updating, the target inventory standard calculating unit 13 calculates using a loss (subscript k−1) accumulated in association with the current inventory standard of 100 units. It should be noted that the loss (subscript k) accumulated in association with the current target inventory standard is utilized for further updating the updated subsequent target inventory standard (subscript k+1), in other words, utilized for calculating in update for a target inventory standard for the period after next (subscript k+2).

As described above, in this example embodiment, it is possible to suppress that since the current inventory standard is not changed, the inventory quantity of the product is maintained at the value of the inventory standard that is unchanged at all times. That is to say, by allowing a change in the inventory standard in product inventory management, it is possible to properly set the replenishment quantity of the product, which enables appropriate inventory management.

### Second Example Embodiment

Next, a second example embodiment of the present disclosure will be described. The information processing apparatus 10 in this example embodiment has the same configuration as in the first example embodiment described above. In addition to this, the information processing apparatus 10 includes the following configuration. Hereinafter, a configuration different from the above will be mainly described.

The output unit 15 of the information processing apparatus 10 in this example embodiment has a function of calculating and outputting the replenishment quantity of product by using the value of the inventory standard changed as described above. For example, the output unit compares the current inventory quantity with the value of the changed inventory standard, and calculates and outputs a value obtained by subtracting the current inventory quantity from the value of the inventory standard as the replenishment quantity of product. Therefore, when the value of the inventory standard is equal to or less than the inventory quantity, the replenishment of product is not performed. Consequently, it is possible to properly manage the inventory quantity of product.

### Third Example Embodiment

Next, a third example embodiment of the present disclosure will be described. The information processing apparatus 10 in this example embodiment has the same configuration as in the first and second example embodiments described above. Then, in this example embodiment, a product subjected to inventory management is not limited to an article, and may be a service. In this case, the inventory quantity of products, the value of an inventory standard, the value of a target inventory standard, and a replenishment quantity may be the number of frames to which the service can be provided, or may be the number of persons who provide the service. Therefore, replenishing a product in inventory management may correspond to increasing a service provision time, a service provision space, and the number of persons who provide the service. As an example, the service includes a food and drink provision service by a restaurant and the like and a guest room provision service by a hotel and the like, but may be a service of any content.

### Fourth Example Embodiment

Next, a fourth example embodiment of the present disclosure will be described with reference to the drawings. This example embodiment shows the overview of the information processing apparatus and so forth described in the above example embodiments. The drawings may be related to any of the example embodiments.

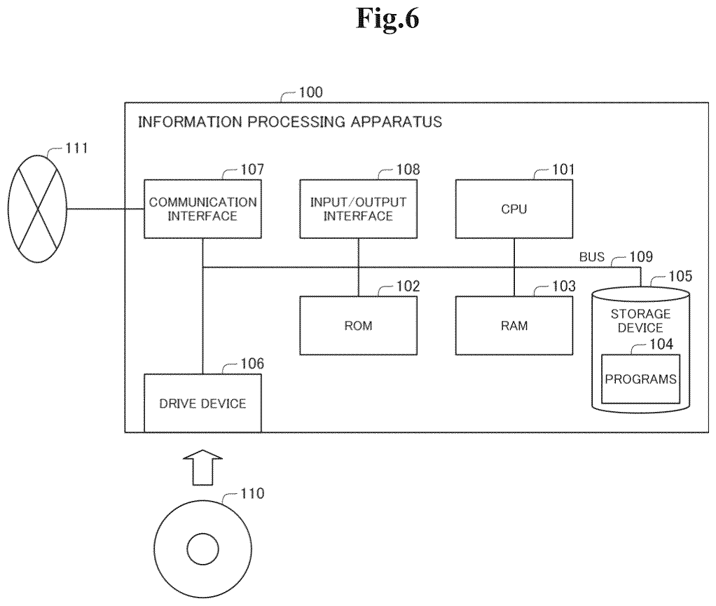

First, a hardware configuration of an information processing apparatus 100 in the present disclosure will be described. The information processing apparatus 100 is configured with a general information processing apparatus and, as an example, has the following hardware configuration as shown in FIG. 6, including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 6 shows an example of a hardware configuration of an information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the abovementioned CPU.

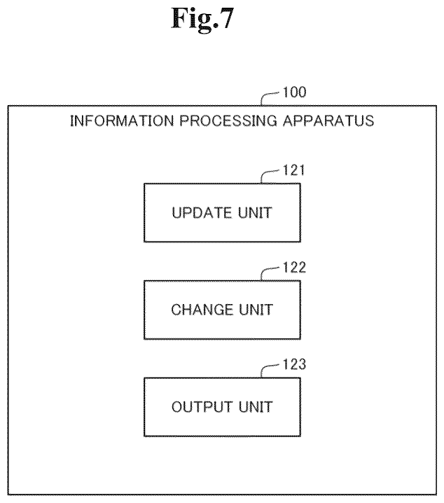

Then, the information processing apparatus 100 can construct and include an update unit 121, a change unit 122, and an output unit 123 shown in FIG. 7 by acquisition and execution of the program 104 by the CPU 101. The programs 104 are, for example, stored in advance in the storage device 105 or the ROM 102, and are loaded into the RAM 103 and executed by the CPU 101 as necessary. Moreover, the programs 104 may be provided to the CPU 101 via the communication network 111, or the programs may be stored in advance in the storage medium 110 and read out by the drive device 106 and provided to the CPU 101. However, the update unit 121, the change unit 122 and the output unit 123 described above may be constructed using dedicated electronic circuits for implementing such means.

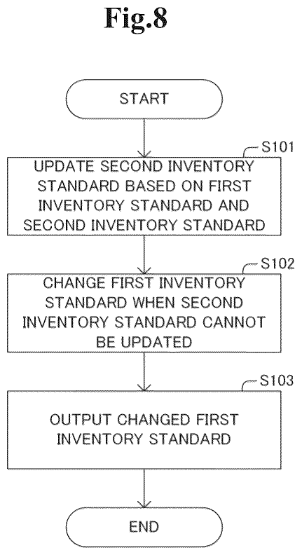

The update unit 121 updates a second inventory standard based on comparison between a first inventory standard to be a product inventory quantity standard and the second inventory standard to be a target value of the first inventory standard (step S101 of FIG. 8). The change unit 122 changes the first inventory standard when the second inventory standard cannot be updated based on the comparison (step S102 of FIG. 8). The output unit 123 outputs the changed first inventory standard (step S103 of FIG. 8).

In the above configuration, the information processing apparatus 100 first compares the first inventory standard with the second inventory standard, and when the first and second inventory standards match, updates the second inventory standard. On the other hand, the information processing apparatus 100 compares the first inventory standard with the second inventory standard and, when the first and second inventory standards do not match, cannot update the second inventory standard. In this case, the information processing apparatus 100 changes the first inventory standard, and outputs the changed first inventory standard. Consequently, as an example, in a case where the first inventory standard is set to 100 units and the second inventory standard is set to 70 units and the inventory quantity is 90 units, the information processing apparatus 100 can change the first inventory standard from 100 units to, for example, 90 units. Then, by using the changed first inventory standard, the information processing apparatus 100 can determine a proper replenishment quantity in accordance with the inventory quantity. That is to say, it is possible to suppress that the first inventory standard is unchanged, and it is possible to perform appropriate inventory management.

At least one or more functions of the functions of the update unit 121, the change unit 122, and the output unit 123 described above may be executed by an information processing apparatus installed and connected anywhere on the network, that is, may be executed by so-called cloud computing.

Further, the abovementioned program can be stored using various types of non-transitory computer-readable mediums and provided to a computer. The non-transitory computer-readable medium includes various types of tangible storage mediums. Examples of the non-transitory computer-readable medium include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, and a semiconductor memory (e.g., mask ROM, PROM (Programmable ROM), EPROM (Erasable PROM), flash ROM, RAM (Random Access Memory)). In addition, the program may be provided to the computer by various types of transitory computer-readable mediums. Examples of the transitory computer-readable mediums include electrical signals, optical signals, and electromagnetic waves. The transitory computer-readable medium can provide the program to the computer via a wired communication channel such as an electric wire and an optical fiber, or via a wireless communication channel.

Although the present disclosure has been described above with reference to the example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiments as necessary.

### SUPPLEMENTARY NOTES

The whole or part of the example embodiments disclosed above can be described as the following supplementary notes. Hereinafter, the overview of an information processing apparatus, an information processing method, and a program in the present disclosure will be described. However, the present disclosure is not limited to configurations described in the following supplementary notes.

All or some of the configurations described in Supplementary Notes 2 to 8 dependent on Supplementary Note 1 below and the functions by such configurations may be dependent on other Supplementary Notes 9 and 10 by the same dependence as Supplementary Notes 2 to 8. Furthermore, not limited to Supplementary Notes 1, 9 and 10, within the scope of the example embodiments described above, all or some of the configurations described as supplementary notes and functions by such configurations may be dependent on hardware, software, various recording means for recording software, or system.

### (Supplementary Note 1)

An information processing apparatus comprising:
an update unit configured to update a second inventory standard based on comparison between a first inventory standard and the second inventory standard, the first inventory standard being a standard of a product inventory quantity, the second inventory standard being a target value of the first inventory standard;
a change unit configured to change the first inventory standard when the second inventory standard cannot be updated based on the comparison; and
an output unit configured to output the first inventory standard having been changed.

### (Supplementary Note 2)

The information processing apparatus according to supplementary note 1, wherein
the update unit is configured to update the second inventory standard when a value of the first inventory standard becomes equal to or less than a value of the second inventory standard.

### (Supplementary Note 3)

The information processing apparatus according to supplementary note 1, wherein
the change unit is configured to change a value of the first inventory standard to bring it closer to a value of the second inventory standard.

### (Supplementary Note 4)

The information processing apparatus according to supplementary note 1, comprising
a calculation unit configured to calculate a loss corresponding to the inventory quantity, wherein
the update unit is configured to update the second inventory standard based on the loss.

### (Supplementary Note 5)

The information processing apparatus according to supplementary note 4, wherein
the calculation unit is configured to allocate the loss to either a first loss corresponding to the first inventory standard or a second loss corresponding to the second inventory standard; and
the update unit is configured to update the second inventory standard to be an update target at a predetermined timing based on either the first loss or the second loss.

### (Supplementary Note 6)

The information processing apparatus according to supplementary note 5, wherein
the update unit is configured to update the second inventory standard based on the first loss, and update the second inventory standard having been updated, based on the second loss.

### (Supplementary Note 7)

The information processing apparatus according to supplementary note 4, wherein
the calculation unit is configured to calculate the loss based on a subgradient of a cost function in which a value of the loss increases as the product inventory quantity is more surplus and more insufficient

### (Supplementary Note 8)

The information processing apparatus according to supplementary note 1, wherein
the output unit is configured to output a product replenishment quantity based on the inventory quantity and the first inventory standard having been changed.

### (Supplementary Note 9)

An information processing method comprising:
updating a second inventory standard based on comparison between a first inventory standard and the second inventory standard, the first inventory standard being a standard of a product inventory quantity, the second inventory standard being a target value of the first inventory standard;
changing the first inventory standard when the second inventory standard cannot be updated based on the comparison; and
outputting the first inventory standard having been changed.

### (Supplementary Note 10)

A non-transitory computer-readable storage medium storing a program, the program comprising instructions for causing an information processing apparatus to execute processes to:
update a second inventory standard based on comparison between a first inventory standard and the second inventory standard, the first inventory standard being a standard of a product inventory quantity, the second inventory standard being a target value of the first inventory standard;
change the first inventory standard when the second inventory standard cannot be updated based on the comparison; and
output the first inventory standard having been changed.

### REFERENCE SIGNS LIST

10 information processing apparatus
11 input unit
12 loss calculating unit
13 target inventory standard calculating unit
14 inventory standard calculating unit
15 output unit 16 inventory quantity storage unit 17 loss storage unit 18 target inventory standard storage unit 100 information processing apparatus
101 CPU
102 ROM
103 RAM
104 programs
105 storage device
106 drive device
107 communication interface
108 input/output interface
109 bus
110 storage medium
111 communication network
121 update unit
122 change unit
123 output unit

1. An information processing apparatus comprising:
at least one memory storing processing instructions; and
at least one processor configured to execute the processing instructions to:
update a second inventory standard based on comparison between a first inventory standard and the second inventory standard, the first inventory standard being a standard of a product inventory quantity, the second inventory standard being a target value of the first inventory standard;
change the first inventory standard when the second inventory standard cannot be updated based on the comparison; and
output the first inventory standard having been changed.

2. The information processing apparatus according to claim 1, wherein the at least one processor is configured to execute the processing instructions to
update the second inventory standard when a value of the first inventory standard becomes equal to or less than a value of the second inventory standard.

3. The information processing apparatus according to claim 1, wherein the at least one processor is configured to execute the processing instructions to
change a value of the first inventory standard to bring it closer to a value of the second inventory standard.

4. The information processing apparatus according to claim 1, wherein the at least one processor is configured to execute the processing instructions to:
calculate a loss corresponding to the inventory quantity; and
furthermore, update the second inventory standard based on the loss.

5. The information processing apparatus according to claim 4, wherein the at least one processor is configured to execute the processing instructions to:
allocate the loss to either a first loss corresponding to the first inventory standard or a second loss corresponding to the second inventory standard; and
update the second inventory standard to be an update target at a predetermined timing based on either the first loss or the second loss.

6. The information processing apparatus according to claim 5, wherein the at least one processor is configured to execute the processing instructions to
update the second inventory standard based on the first loss, and update the second inventory standard having been updated, based on the second loss.

7. The information processing apparatus according to claim 4, wherein the at least one processor is configured to execute the processing instructions to
calculate the loss based on a subgradient of a cost function in which a value of the loss increases as the product inventory quantity is more surplus and more insufficient.

8. The information processing apparatus according to claim 1, wherein the at least one processor is configured to execute the processing instructions to
output a product replenishment quantity based on the inventory quantity and the first inventory standard having been changed.

9. An information processing method comprising:
updating a second inventory standard based on comparison between a first inventory standard and the second inventory standard, the first inventory standard being a standard of a product inventory quantity, the second inventory standard being a target value of the first inventory standard;
changing the first inventory standard when the second inventory standard cannot be updated based on the comparison; and
outputting the first inventory standard having been changed.

10. The information processing method according to claim 9, comprising
updating the second inventory standard when a value of the first inventory standard becomes equal to or less than a value of the second inventory standard.

11. The information processing method according to claim 9, comprising
changing a value of the first inventory standard to bring it closer to a value of the second inventory standard.

12. The information processing method according to claim 9, comprising
calculating a loss corresponding to the inventory quantity; and
furthermore, updating the second inventory standard based on the loss.

13. The information processing method according to claim 9, comprising
outputting a product replenishment quantity based on the inventory quantity and the first inventory standard having been changed.

14. A non-transitory computer-readable storage medium storing a program, the program comprising instructions for causing an information processing apparatus to execute processes to:
update a second inventory standard based on comparison between a first inventory standard and the second inventory standard, the first inventory standard being a standard of a product inventory quantity, the second inventory standard being a target value of the first inventory standard;
change the first inventory standard when the second inventory standard cannot be updated based on the comparison; and
output the first inventory standard having been changed.
